(19) United States
(12) Patent Application Publication
(10) Pub. No.: US 2014/0141195 A1
(43) Pub. Date: May 22, 2014

(54) FIXED ARRAY ACFs WITH MULTI-TIER PARTIALLY EMBEDDED PARTICLE MORPHOLOGY AND THEIR MANUFACTURING PROCESSES

(71) Applicants: Rong-Chang Liang, Cupertino, CA (US); Maung Kyaw Aung, Union City, CA (US); Yuhao Sun, Fremont, CA (US); An-Yu Ma, Fremont, CA (US)

(72) Inventors: Rong-Chang Liang, Cupertino, CA (US); Maung Kyaw Aung, Union City, CA (US); Yuhao Sun, Fremont, CA (US); An-Yu Ma, Fremont, CA (US)

(21) Appl. No.: 13/678,935

(22) Filed: Nov. 16, 2012

(51) Int. Cl. H01B 7/00

(52) U.S. Cl. CPC H01B 7/00
USPC 428/98; 427/58

(57) ABSTRACT

An anisotropic conductive film (ACF) comprising: (a) an adhesive layer having a substantially uniform thickness; and (b) a plurality of conductive particles individually adhered to the adhesive layer, wherein the conductive particles include a first non-random array of particle sites partially embedded at a first depth within the adhesive layer and a second fixed non-random array or dispersion of conductive particles partially embedded at a second depth or a dispersion of conductive particles fully embedded within the adhesive layer, wherein the first depth and the second depth are distinctly different. The ACF may be supplied as a sheet, a continuous film or as a roll and the multi-tier morphology may be present throughout the length of the product or in select areas.

### BACKGROUND

This disclosure relates generally to structures and manufacturing methods for anisotropic conductive films (ACF) with multi-tier partially embedded particles. More particularly, this disclosure relates to structures and manufacturing processes for an ACF having improved particle capture, contact resistance and peeling strength in which one or more non-random arrays of conductive particles are partially embedded at two or multiple distinct depths in the ACF thereby making them readily accessible for bonding to an electronic device. The term “depth” refers to the portion of the particle diameter that is below the top surface of the ACF adhesive. The disclosure also relates to ACFs in which the foregoing advantages are available at lower average particle density than in ACFs without the two tier construction.

Anisotropic Conductive Films (ACF) are commonly used in flat panel display driver integrated circuit (IC) bonding. A typical ACF bonding process comprises a first step in which the ACF is attached onto the electrodes of the panel glass; a second step in which the driver IC bonding pads are aligned with the panel electrodes; and a third step in which pressure and heat are applied to the bonding pads to melt and cure the ACF within seconds. The conductive particles of the ACF provide anisotropic electrical conductivity between the panel electrodes and the driver IC. ACF has also been used widely in applications such as flip chip bonding and photovoltaic module assembly.

The need for ultra-fine pitch ACFs increases dramatically as the use of high definition displays in electronic devices such as smart phones and electronic tablets become the market trend. However, as the pitch size decreases, the size of the electrodes must also become smaller and a higher concentration of conductive particles is needed to provide the required particle density on the connected electrodes to assure satisfactory electrical conductivity or impedance.

The conductive particles of a traditional ACF are typically randomly dispersed in the ACF. There is a limitation on the particle density of such a dispersion system due to X-Y conductivity. In many bonding processes using traditional ACFs, only a small fraction of conductive particles are captured on electrodes. Most of the particles are actually flushed out to the spacing area between electrodes and in some case result in undesirable shorts in the X-Y plane of the ACF. In a fine pitch bonding application, the conductive particles density must be high enough to have an adequate number of conductive particles bonded on each bonding pad. However, the probability of a short circuit or undesirable high-conductivity in the insulating area between two bonding pads also increases due to the high density of conductive particles and the characteristics of random dispersion.

U.S. Published Application 2010/0101700 to Liang et al. (“Liang '700”) discloses a technique which overcomes some of the shortcomings of ACF having randomly dispersed conductive particles. Liang discloses that conductive particles are arranged in pre-determined array patterns in fixed-array ACF (FACF). Such a non-random array of conductive particles is capable of ultra fine pitch bonding without the same likelihood of a short circuit. In contrast, the conductive particles of fixed array ACFs are pre-arranged on the adhesive surface and have shown a significantly higher particle capture rate with a lower particle concentration than traditional ACFs. Since the conductive particles are typically high cost, narrowly dispersed Au particles with a polymer core, fixed array ACFs provide a significantly lower cost solution with a superior performance as compared to the traditional ones.

### SUMMARY OF THE DISCLOSURE

This disclosure augments the fixed-array ACF of Liang '700 by providing an ACF in which the conductive particles are arranged in two tiers within the ACF. While U.S. application Ser. No. 13/111,300 (“Liang '300”) discloses that the conductive particles can be partially embedded in the adhesive resin such that at least a portion of the particle (e.g., about ⅓ to ¾ in diameter) is not covered by the adhesive, it has been found that a multi-tier fixed array disclosed herein provides a further improvement in the particle capture rate and shows a lower contact resistance and a higher peeling force as compared with a normal fixed array ACF without the tiered particle morphology. While this disclosure frequently refers to a two-tier array, the disclosure is also open to embodiments in which one or more additional tiers are provided. The term “multi-tier” includes ACFs having two or more tiers of particle arrays as well as ACFs in which a fixed non-random array of conductive particles is partially embedded in the surface of an ACF containing a random dispersion of fully embedded particles.

One illustration of the effect that is available by practicing this disclosure is shown in Table 1 below for a two-tier non-random fixed array particle morphology:

TABLE 1

| | | | Contact | Peeling |
|---|---|---|---|---|
| | Average | Particle | resistance | Strength |
| | Particle | capture | @170 C./5 sec | @170 C./5 sec |
| | density | rate | (ohm/electrode) | (Kgf/in) |
| Two-tier | About | 37.60% | 2.90 | 1.63 |
| morphology | 16000/mm² | | | |
| Single plane | About | 34.40% | 3.56 | 1.16 |
| morphology | 17000/mm² | | | |

It's evident from Table 1 that even though of a slightly lower particle density, the ACF having the two-tier particle morphology showed a significantly higher particle capture rate, and a better (lower) contact resistance and a higher peeling force while the other performance remained essentially the same. The two-tier particle morphology is also retained very well after the samples were aged for more than 3 months in normal storage conditions. Not to be bound by the theory, it's believed that with some of the particles embedded into the adhesive more than the others in a given fixed array ACF, the undesirable turbulence induced by the melt flow of the adhesive during bonding is reduced and the local effective bonding pressure experienced on the contact particles increases. Both result in fewer particles being flushed out of the connecting electrodes and in turn a higher capture rate, a lower contact resistance and a higher adhesion strength.

One manifestation of the invention is an anisotropic conductive film (ACF) comprising: (a) an adhesive layer having a substantially uniform thickness; and (b) a plurality of conductive particles that are individually adhered to the adhesive layer, wherein the conductive particles include a first non-random array of particles partially embedded at a first depth within the adhesive layer, and either a second array of conductive particles partially embedded at a second depth, or a dispersion of conductive particles that are fully embedded and dispersed within the adhesive layer, wherein the depths at which the first array and the second array or dispersion are are embedded in the adhesive are distinctly different, for example, a 20 or 30% difference.

For example, in one embodiment, the disclosure provides an ACF including two fixed non-random arrays with the first fixed array partially embedded and the second fixed array fully embedded into the adhesive layer of the ACF.

In a second embodiment, the ACF may include two fixed non-random arrays in which the conductive particles are partially embedded to different extents in the surface of the adhesive layer of the ACF.

In a third embodiment, one fixed non-random array is partially embedded in the adhesive layer and a random dispersion of conductive particles is dispersed in the adhesive layer in which the fixed array of particles is embedded. Other embodiments including additional tiers of arrays of particles are also possible.

Another manifestation of the invention is an anisotropic conductive film (ACF) comprising: (a) an adhesive layer having a substantially uniform thickness; and (b) a plurality of conductive particles individually adhered to the adhesive layer, wherein the conductive particles include a first non-random array of particles partially embedded at a first depth within the adhesive layer and a second non-random array of conductive particles partially embedded at a second depth within the adhesive layer wherein the first depth and the second depths are distinctly different.

In accordance with one embodiment, a multi-tier ACF is made using a multiple transfer process including the steps of:

(a) transferring a first fixed array of particles to an adhesive layer;

(b) processing the first array to the desirable degree of partial embedding using, for example, heating and/or a pressure roller or calendaring;

(c) transferring a second fixed array of particles to the adhesive; and

(d) optionally pressing both arrays of particles to the desired degree of partial embedding such that the first array is embedded in the adhesive to a greater extent than the second array.

In accordance with another embodiment, a multi-tier ACF is made using a multiple transfer process including the steps of:

(a) transferring a first fixed non-random array of conductive particles to an ACF having conductive particles dispersed therein; and

(b) processing the first array to the desirable degree of partial embedding using, for example, heating and/or a pressure roller or calendaring.

The ACF may be formed uniformly with a multi-tier particle morphology or the multi-tier morphology may be used in select areas of the ACF in which the conductive particles are uniformly dispersed in the adhesive outside of the multi-tier areas. In one manifestation of the invention, the ACF can be a sheet or a continuous film or a continuous film in the form of a reel or roll. In one embodiment the ACF be be supplied as a roll of about 1.0-2.0 mm (width)×about 20-300 meter (length) wrapped between a plastic holder. In another embodiment the ACF may be a continuous film or reel in which select areas have a multi-tier morphology as disclosed herein.

### BRIEF DESCRIPTION OF THE DRAWINGS

FIG. 1 is Representative SEM micrographs of two fixed array ACFs having a two-tier particle morphology. Average particle density: (1A) about 24000 pcs/mm² and (1B) about 16,000 pcs/mm². All the particles are partially embedded in the adhesive with some of the particles embedded deeper into the adhesive.

FIG. 2 is Representative SEM (2A) and optical microscopic (2B) micrographs of a prior art fixed array ACF without the two-tier particle morphology having an average particle density of about 17,000 pcs/mm².

FIG. 3 is a schematic drawing of a single fixed array ACF having an one-tier particle morphology and the corresponding distribution of particle embedment depth.

FIG. 4 is a schematic drawing of a two-tier fixed array ACF of the same pitch size having a two-tier particle morphology and the corresponding distribution of particle embedment depth.

FIG. 5 is a schematic of a two-tier fixed array ACF in which the microcavities employed for the transfer of the two tiers of fixed array particles have a different pitch size.

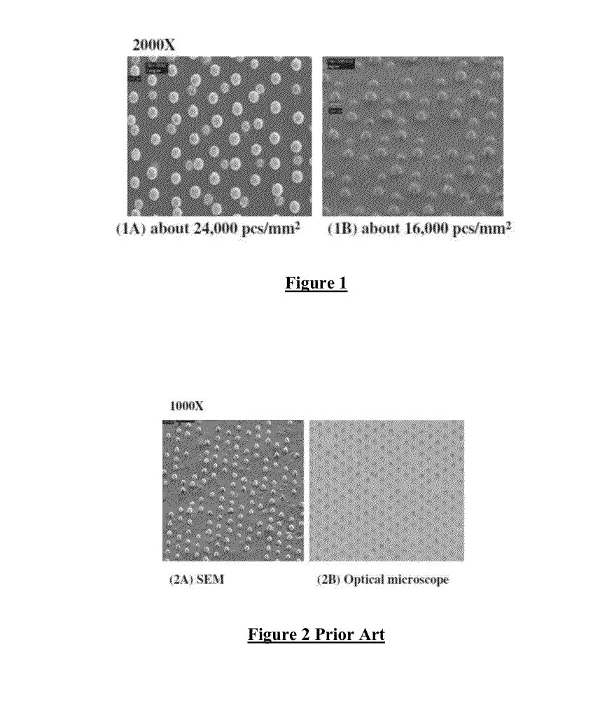

### DETAILED DESCRIPTION

U.S. Published Application 2010/0101700 and U.S. application Ser. No. 13/111,300 filed May 19, 2011 to Liang et al. are incorporated herein in their entirety by reference.

A microcavity array containing microcavities of about 6 μm (diameter) by about 4 μm (depth) by about 3 μm (partition) that is useful in transferring the conductive particles to the surface of the adhesive layer can be prepared by laser ablation on an approximately 2 to 5 mil heat-stabilized polyimide (PI) or a polyester film such as PET to form the microcavity carrier. The microcavity array web is coated with a conductive particle dispersion using a smooth rod. More than one filling may be employed to assure no unfilled microcavities. See Liang '300 and Liang '700.

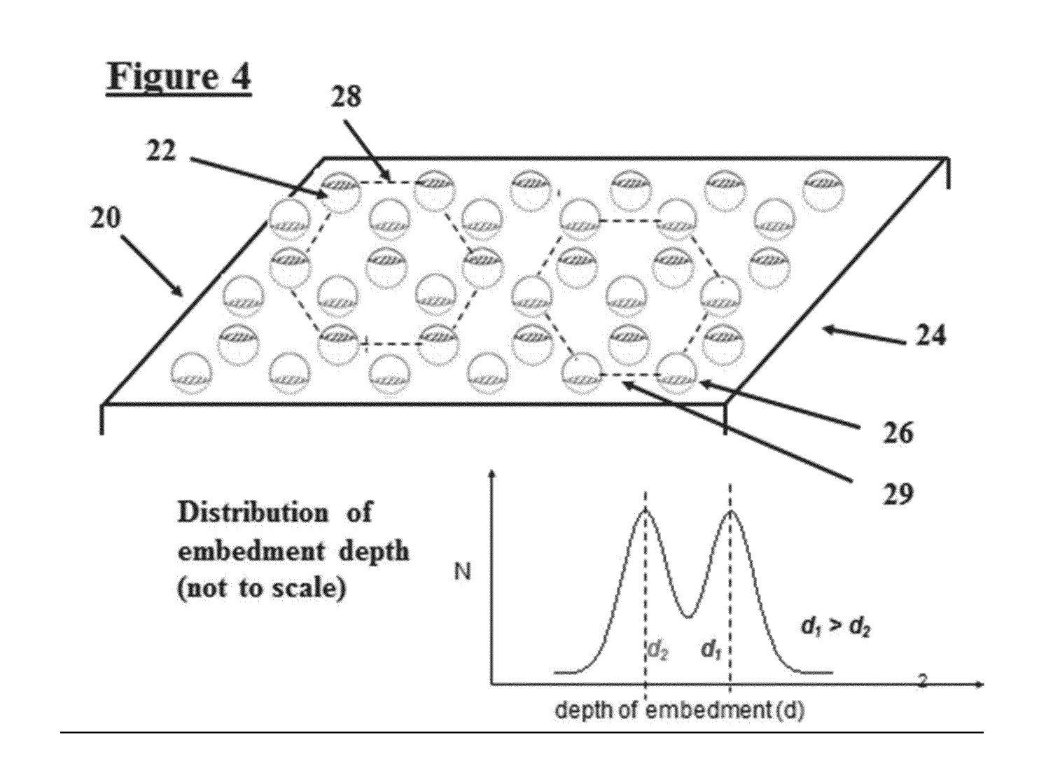

The two-tier (or multi-tier) ACF may be obtained by a double (or multiple) transfer process. In one embodiment, an adhesive (preferably an epoxy adhesive) is coated on a release liner and two microcavity films are prepared according to the methods taught in Liang '700. The two microcavity films may have the same or different microcavity patterns and pitch. Conductive particles are filled into the first microcavity film and excess particles outside of the cavities are removed using, for example, a rubber wiper or a rubber roller with a carefully controlled gap between the microcavity film and the wiper or roller. The conductive particles in the microcavity film are transferred to the epoxy adhesive by for example, laminating the filled microcavity film with the epoxy adhesive/release liner. As part of the laminating step or as a separate step, the thus transferred particles are or may be further pressed into adhesive film to allow only about 0 to 80% of the particle diameter exposed above the adhesive surface by for example, calendaring, laminating, or heating under pressure or shear. The particle filling and transfer processes were repeated with a second microcavity film to produce the two-tier particle morphology as shown in FIGS. 1 and 4.

In another embodiment, a ACF may be obtained by transferring a fixed array of particles onto a ACF (non-fixed array) in which the conductive particles are randomly dispersed and fully embedded in the conductive adhesive layer. The tiered ACF may be prepared by depositing a fixed array of the particles on a single layer ACF having the conductive particles uniformly dispersed in the adhesive or on a two layer ACF having a separate non-conductive layer underneath conductive adhesive layer onto which the fixed array of particles is transferred.

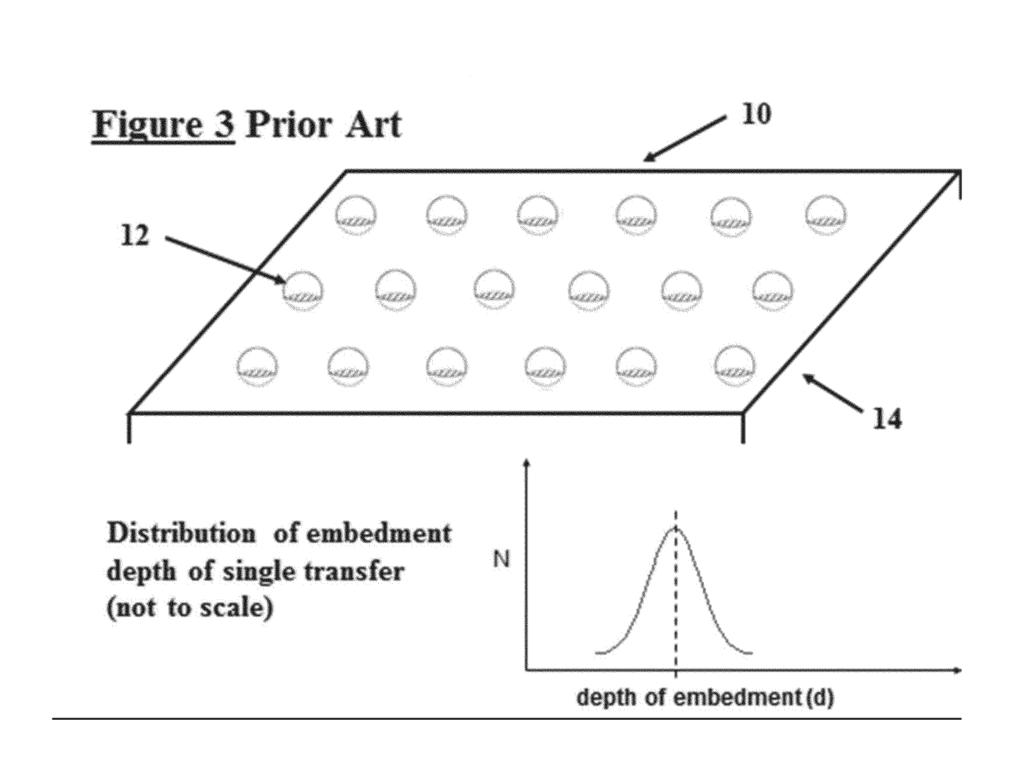

FIG. 3 illustrates a single tier fixed array ACF 10 in which the conductive particles 12 are approximately uniformly embedded in the surface of the ACF adhesive 14. The graph inset in FIG. 3 shows the histogram distribution of the particles as a function of the embedment depth (d). As the graph shows, the distribution is a single-modal distribution. FIG. 4 illustrates schematically an ACF in accordance with one embodiment of the disclosure. The ACF 20 includes a first array of conductive particles 22 that are embedded in the ACF adhesive 24 a first distance (e.g., d₁) and a second array of conductive particles 26 that are embedded in the ACF a second but shallower distance (e.g., d₂) than the first particles 22. The pitch or the distance between adjacent particles in a particular array (i.e., the first array designated by the dotted hexagon 28 and the second array designated by the dotted hexagon 29) have the same pitch. The inset to FIG. 4 is a graph illustrating the distribution of embedment depth. This graph shows that the distribution is bimodal including two arrays of particles at distinctly different embedment depths (d₁ and d₂).

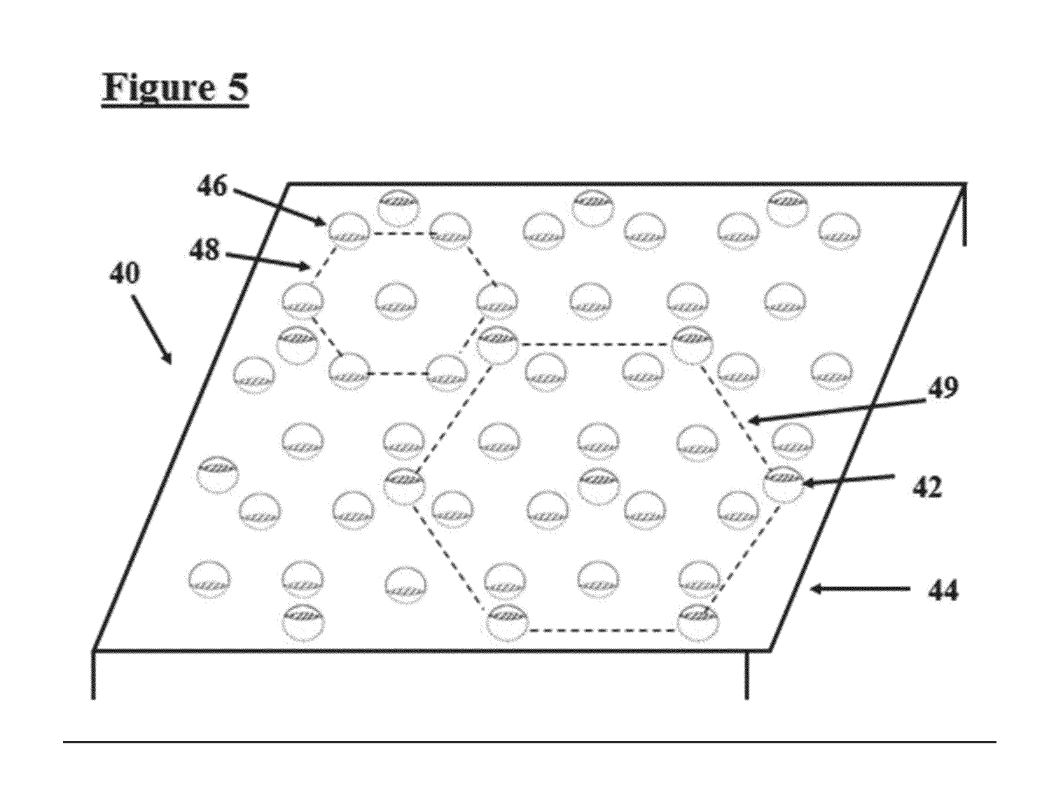

FIG. 5 illustrates a further embodiment of the invention in which the ACF 40 includes a first array of particles 42 that are embedded in the ACF adhesive 44 at a first depth and a second array of particles 46 that are embedded in the ACF adhesive at a shallower depth. The ACF 40 in FIG. 5 is different from the ACF 20 illustrated in FIG. 4 in that the pitch of the particles making up the first and second arrays is different. The dotted line 48 illustrating the pitch of the second array of particles 46 is shorter than the dotted line 49 connecting adjacent particles 42 in the deeper first array of particles 42.

In accordance with another embodiment of the invention, a two-tier ACF can be prepared by starting with an ACF having conductive particles dispersed in the adhesive and transferring to the surface of that ACF adhesive a fixed non-random array of particles and embedding those particles to the desired embedment depth.

Any of the conductive particles previously taught for use in ACFs may be used in practicing this disclosure. Gold coated particles are used in one embodiment. In one embodiment, the conductive particles have a narrow particle size distribution with a standard deviation of less than 10%, preferably less than 5%, even more preferably less than 3%. The particle size is preferably in the range of about 1 to 250 μm, more preferably about 2-50 μm, even more preferably about 2.5-10 μm. Two types of commercially available conductive particles that are useful in the invention are Ni/Au particles from Nippon Chemical through its distributor, JCI USA, in New York, a subsidiary of Nippon Chemical Industrial Co., Ltd., White Plains, N.Y. and the Ni particles from Inco Special Products, Wyckoff, N.J. In one embodiment the conductive particles may have a bimodal or a multimodal particle size distribution. In one embodiment the size of the microcavities and the conductive particles are selected so that each microcavity has a limited space to contain only one conductive particle. In a specific embodiment, the electrically conductive particle or microcavity having a diameter or depth in a range between about 1 to about 100 μm. In another embodiment, the electrically conductive particle or microcavity having a diameter or depth in a range between about 2 to about 10 μm. In another embodiment, the electrically conductive particle or microcavity having a diameter or depth with a standard deviation of less than about 10%.

In another preferred embodiment, the electrically conductive particle or microcavity has a diameter or depth with a standard deviation of less than about 5%. In another preferred embodiment, the adhesive layer comprises a thermoplastic, thermoset, or their precursors.

In one embodiment, conductive particles including a polymeric core and a metallic shell are used. Useful polymeric cores include but are not limited to, polystyrene, polyacrylates, polymethacrylates, polyvinyls, epoxy resins, polyurethanes, polyamides, phenolics, polydienes, polyolefins, aminoplastics such as melamine formaldehyde, urea formaldehyde, benzoguanamine formaldehyde and their oligomers, copolymers, blends or composites. If a composite material is used as the core, nanoparticles or nanotubes of carbon, silica, alumina, BN, TiO₂ and clay are preferred as the filler in the core. Suitable materials for the metallic shell include, but are not limited to, Au, Pt, Ag, Cu, Fe, Ni, Sn, Al, Mg and their alloys. Conductive particles having interpenetrating metal shells such as Ni/Au, Ag/Au, Ni/Ag/Au are useful for hardness, conductivity and corrosion resistance. Particles having rigid spikes such as Ni, carbon, graphite are useful in improving the reliability in connecting electrodes susceptible to corrosion by penetrating into the corrosive film if present. Such particles are available from Sekisui KK (Japan) under the trade name MICROPEARL, Nippon Chemical Industrial Co., (Japan) under the trade name BRIGHT, and Dyno A. S. (Norway) under the trade name DYNOSPHERES.

In another embodiment, the conductive particles may have a so called spiky surface. The spike might be formed by doping or depositing small foreign particles such as silica on the latex particles before the step of electroless plating of Ni followed by partial replacement of the Ni layer by Au. In one embodiment as explained in more detail in the aforementioned applications, the conductive particles are formed with spikes. These spikes may be formed as, without limitation, sharpened spikes, nodular, notches, wedges, or grooves. In another embodiment, the conductive particles may be pre-coated with a thin insulating layer, preferably an insulating polymer layer with a melt flow temperature near or lower than the bonding temperature.

Narrowly dispersed polymer particles may be prepared by, for example, seed emulsion polymerization as taught in U.S. Pat. Nos. 4,247,234, 4,877,761, 5,216,065 and the Ugelstad swollen particle process as described in Adv., Colloid Interface Sci., 13, 101 (1980); J. Polym. Sci., 72, 225 (1985) and “Future Directions in Polymer Colloids”, ed. El-Aasser and Fitch, p. 355 (1987), Martinus Nijhoff Publisher. In one embodiment, monodispersed polystyrene latex particle of about 5 μm diameter is used as a deformable elastic core. The particle is first treated in methanol under mild agitation to remove excess surfactant and to create microporous surfaces on the polystyrene latex particles. The thus treated particles are then activated in a solution comprising PdCl₂, HCl and SnCl₂ followed by washing and filtration with water to remove the Sn⁴⁺ and then immersed in an electroless Ni plating solution (from for example, Surface Technology Inc, Trenton, N.J.) comprising a Ni complex and hydrophosphite at 90° C. for about 30 to about 50 minutes. The thickness of the Ni plating is controlled by the plating solution concentration and the plating temperature and time.

A release layer may be applied onto the microcavity to improve the transfer of the conductive particles onto the adhesive layer. The release layer may be selected from the list comprising fluoropolymers or oligomers, silicone oil, fluorosilicones, polyolefines, waxes, poly(ethyleneoxide), poly(propyleneoxide), surfactants with a long-chain hydrophobic block or branch, or their copolymers or blends. The release layer is applied to the surface of the microcavity array by methods including, but are not limited to, coating, printing, spraying, vapor deposition, plasma polymerization or cross-linking As illustrated in the Liang '300 application, in another embodiment, the method further includes a step of employing a close loop of microcavity array. In another embodiment, the method further includes a step of employing a cleaning device to remove residual adhesive or particles from the microcavity array after the particle transfer step. In a different embodiment, the method further includes a step of applying a release layer onto the microcavity array before the particle filling step. In another embodiment, the conductive particles may be encapsulated or coated with a thermoplastic or thermoset insulating layer to further reduce the risk of short circuit in the X-Y plane as disclosed in U.S. Pat. Nos. 6,632,532; 7,291,393; 7,410,698; 7,566,494; 7,815,999; 7,846,547 and US Patent Applications 2006/0263581; 2007/0212521; and 2010/0327237. In accordance with one embodiment, the conductive particles are treated/coated with a coupling agent. The coupling agent enhances corrosion resistance of the conductive particles as well as the wet adhesion, or the binding strength in humid conditions, of the particles to electrodes having metal-OH or metal oxide moiety on the electrode surface, so that the conductive particles can be only partially embedded in the adhesive, such that they are readily accessible for bonding the electrical device. More importantly, the surface treated conductive particles can be better dispersed with a reduced risk of aggregation in the adhesive of the non-contact area or the spacing area among electrodes. As a result, the risk of short circuit in the X-Y plane is significantly reduced, particularly in the fine pitch applications.

Examples of useful coupling agents to pre-treat the conductive particles include titanate, zirconate and silane coupling agents (“SCA”) such as organotrialkoxysilanes including 3-glycidoxpropyltrimethoxy-silane, 2-(3,4-epoxycyclohexyl)ethyltrimethoxysilane, gamma-mercaptopropyltrimethoxysilane, bis(3-triethoxysilylpropyl)tetrasulfide and bis(3-triethoxysilylpropyl)disulfide. The coupling agents containing thiol, disulfide,and tetrasulfide functional groups are particularly useful to pre-treat Au particles due to the formation of Au—S bond even in mild reaction conditions (See for example, J. Am. Chem. Soc., 105 4481 (1983) Adsorption of Bifunctional Organic Disulfides on Gold Surfaces.) The coupling agent may be applied to the surface of the conductive particle in an amount of about 5% to 100% of surface coverage, more particularly about 20% to 100% of surface coverage, even more particularly, 50% to 100% of surface coverage For references, see J. Materials Sci., Lett., 8 99], 1040 (1989); Langmuir, 9 (11), 2965-2973 (1993); Thin Solid Films, 242 (1-2), 142 (1994); Polymer Composites, 19 (6), 741 (1997); and “Silane Coupling Agents”, 2^{nd} Ed., by E. P. Plueddemann, Plenum Press, (1991) and references therein.

The microcavity array may be formed directly on a carrier web or on a cavity-forming layer pre-coated on the carrier web. Suitable materials for the web include, but are not limited to polyesters such as polyethylene terephthalate (PET) and polyethylene naphthalate (PEN), polycarbonate, polyamides, polyacrylates, polysulfone, polyethers, polyimides, and liquid crystalline polymers and their blends, composites, laminates or sandwich films. A suitable material for the cavity-forming layer can include, without limitation, a thermoplastic material, a thermoset material or its precursor, a positive or a negative photoresist, or an inorganic material. To achieve a high yield of particle transfer, the carrier web may be preferably treated with a thin layer of release material to reduce the adhesion between the microcavity carrier web and the adhesive layer. The release layer may be applied by coating, printing, spraying, vapor deposition, thermal transfer, or plasma polymerization/crosslinking either before or after the microcavity-forming step. Suitable materials for the release layer include, but are not limited to, fluoropolymers or oligomers, silicone oil, fluorosilicones, polyolefines, waxes, poly(ethyleneoxide), poly(propyleneoxide), surfactants with a long-chain hydrophobic block or branch, or their copolymers or blends.

In one embodiment, particle deposition may be effected by applying a fluidic particle distribution and entrapping process, in which each conductive particle is entrapped into one microcavity. A number of entrapping processes can be used. For example, in one embodiment disclosed in Liang '700, a roll-to-roll continuous fluidic particle distribution process can be used to entrap only one conductive particle into each microcavity. The entrapped particles then can be transferred from the microcavity array to predefined locations on an adhesive layer. Typically, the distance between these transferred conductive particles must be greater than the percolation threshold, which is the density threshold at which the conductive particles aggregate.

The varieties of the patterns dimension, shapes and spacing of the microcavities are disclosed in US published patent applications Liang, US 2006/0280912 and Liang '700. The fixed array patterns may vary. In the case of circular microcavities, the pattern may be represented by X-Y where X is the diameter of the cavity and Y is the edge-to-edge distance between the adjacent cavities in microns. Typical microcavity pattern pitches include 5-3, 5-5, 5-7, and 6-2 patterns. The pattern selected will depend in part on the number of particles required for each electrode. To reduce the minimum bonding space of electrodes, the microcavity pattern may be staggered.

Adopting the particle filling procedure described in the above example, a surface-treated polyimide (PI) microcavity sheet with a 6 (opening)×2 (spacing)×4 (depth) μm array configuration was filled with particles. An epoxy film was prepared with about 15 μm target thickness. The microcavity sheet and the epoxy film were affixed, face to face, on a steel plate. The steel plate was pushed through a HRL 4200 Dry-Film Roll Laminator, commercially available from Think & Tinker. The lamination pressure and lamination speed are adjusted such that this first array of particles is transferred from the microcavity carrier to the adhesive film with a good efficiency (greater than about 90%, preferably greater than about 95%) and with the desired embedment (for example about 40 to 90%) optionally with a post calendaring or heating process to allow a higher degree of embedment. A second array of particles is then transferred to the film and the lamination pressure and lamination speed are adjusted so as to obtain the desired degree of embedment. The transfer of the second fixed array of particles may, depending on conditions, further embed the first array of particles into the adhesive. The pressure, temperature and speed of the second array lamination are adjusted so that the first and second arrays are embedded in the epoxy adhesive to the desired different depths which are different for the first array and the second array of particles. By tiering the embedding depths in this fashion, the improved resistance and pull strength are achieved. In one embodiment, the first array is embedded about 40 to 90% of its particles' diameter and more typically about 50 to 80%. The second array is embedded about 10 to 60% of its particles' diameter and more typically about 30 to 60% provided that the percent embedment is greater for one array than the other array. In particular, it is desirable if the first array particles are embedded at least about 20%, preferably 30%, deeper into the adhesive relative to the embedment depth of the second array particles.

The adhesives used in the ACF may be thermoplastic, thermoset, or their precursors. Useful adhesives include but are limited to pressure sensitive adhesives, hot melt adhesives, heat or radiation curable adhesives. The adhesives may comprise for examples, epoxide, phenolic resin, amine-formaldehyde resin, polybenzoxazine, polyurethane, cyanate esters, acrylics, acrylates, methacrylates, vinyl polymers, rubbers such as poly(styrene-co-butadiene) and their block copolymers, polyolefins, polyesters, unsaturated polyesters, vinyl esters, polycaprolactone, polyethers, and polyamides. Epoxide, cyanate esters and multifunctional acrylates are particularly useful. Catalysts or curing agents including latent curing agents may be used to control the curing kinetics of the adhesive. Useful curing agents for epoxy resins include, but are not limited to, dicyanodiamide (DICY), adipic dihydrazide, 2-methylimidazole and its encapsulated products such as Novacure HX dispersions in liquid bisphenol A epoxy from Asahi Chemical Industry, amines such as ethylene diamine, diethylene triamine, triethylene tetraamine, BF3 amine adduct, Amicure from Ajinomoto Co., Inc, sulfonium salts such as diaminodiphenylsulphone, p-hydroxyphenyl benzyl methyl sulphonium hexafluoroantimonate. In one embodiment the particles may be coated with a coupling agent. Coupling agents including, but are not limited to, titanate, zirconate and silane coupling agents such as glycidoxypropyl trimethoxysilane and 3-aminopropyl trimethoxy-silane may also be used to improve the durability of the ACF. A discussion of the effect of curing agents and coupling agents on the performance of epoxy-based ACFs can be found in S. Asai, et al, J. Appl. Polym. Sci., 56, 769 (1995). The entire paper is hereby incorporated by reference in its entirety.

Fluidic assembly of IC chips or solder balls into recess areas or holes of a substrate or web of a display material has been disclosed in for example, U.S. Pat. Nos. 6,274,508, 6,281,038, 6,555,408, 6,566,744 and 6,683,663. Filling and top-sealing of electrophoretic or liquid crystal fluids into the microcups of an embossed web is disclosed in for example, U.S. Pat. Nos. 6,672,921, 6,751,008, 6,784,953, 6,788,452, and 6,833,943. Preparation of abrasive articles having precise spacing by filling into the recesses of an embossed carrier web, an abrasive composite slurry comprising a plurality of abrasive particles dispersed in a hardenable binder precursor was also disclosed in for example, U.S. Pat. Nos. 5,437,754, 5,820,450 and 5,219,462. All of the aforementioned United States patents are hereby incorporated by reference in their respective entirety. In the above-mentioned art, recesses, holes, or microcups were formed on a substrate by for example, embossing, stamping, or lithographic processes. A variety of devices were then filling into the recesses or holes for various applications including active matrix thin film transistors (AM TFT), ball grid arrays (BGA), electrophoretic and liquid crystal displays. In a particular embodiment an ACF is formed by fluidic filling of only one conductive particle in each microcavity or recess and the conductive particles comprising a polymeric core and a metallic shell and the metallic shell is coated with a coupling agent and more particularly a silane coupling agent and the particle is partially embedded in the ACF adhesive layer.

The microcavities may be formed directly on a plastic web substrate with, or without, an additional cavity-forming layer. Alternatively, the microcavities may also be formed without an embossing mold, for example, by laser ablation or by a lithographic process using a photoresist, followed by development, and optionally, an etching or electroforming step. Suitable materials for the cavity forming layer can include, without limitation, a thermoplastic, a thermoset or its precursor, a positive or a negative photoresist, or an inorganic or a metallic material. As to laser ablating, one embodiment generates an excimer laser beam for ablation having power in the range of between about 0.1 W/cm² to about 200 W/cm² employing a pulsing frequency being between about 0.1 Hz to about 500 Hz; and applying between about 1 pulse to about 100 pulses. In a preferred embodiment, laser ablation power is in the range of between about 1 W/cm² to about 100 W/cm², employing a pulsing frequency of between about 1 Hz to about 100 Hz, and using between about 10 pulses to about 50 pulses. It also is desirable to apply a carrier gas with vacuum, to remove debris.

To enhance transfer efficiency, the diameter of the conductive particles and the diameter of the cavities have specific tolerance. To achieve a high transfer rate, the diameter of the cavities preferably have specific tolerance less than about 5% to about 10% standard deviation requirement is based on the rationales set forth in U.S. Patent Publication 2010/0101700.

In an embodiment, particles in a non-random ACF microcavity array can have a particle size range distributed about a single mean particle size value, typically between about 2 μm to about 6 μm, with embodiments featuring a narrow distribution including a narrow particle size distribution having a standard deviation of less than about 10% from the mean particle size. In other embodiments featuring a narrow distribution, a narrow particle size distribution may be preferred to have a standard deviation of less than about 5% from the mean particle size. Typically, a cavity of a selected cavity size is formed to accommodate a particle having a selected particle size that is slightly smaller than the selected cavity size. To avoid the formation of particle cluster in the ACF, preferably the average diameter of the cavity opening is slightly larger than the particle diameter but is smaller than two times of the particle diameter. More preferably, the average diameter of the cavity opening is larger than 1.5 times of the particle diameter but is smaller than two times of the particle diameter.

Thus, in one embodiment, microcavities in a non-random ACF microcavity array can have a cavity size range distributed about a single mean cavity size value, typically between about 2 μm to about 6 μm, with embodiments featuring a narrow distribution including a narrow cavity size distribution having a standard deviation of less than 10% from the mean cavity size. In other embodiments featuring a narrow distribution, a narrow cavity size distribution may be preferred to have a standard deviation of less than 5% from the mean cavity size.

In a specific embodiment, the invention further discloses a method for fabricating an electronic device. The method includes a step of placing a plurality of electrically conductive particles that include an electrically conductive shell surface-treated or coated with a coupling agent or insulating layer and a core material into an array of microcavities followed by overcoating or laminating an adhesive layer onto the filled microcavities. In a one embodiment, the step of placing a plurality of surface treated conductive particles into an array of microcavities comprises a step of employing a fluidic particle distribution process to entrap each of the conductive particles into a single microcavity.

According to above descriptions, drawings and examples, this invention discloses an anisotropic conductive film (ACF) that includes a plurality of electrically conductive surface treated particles disposed in predefined two-tiered non-random particle locations as a non-random fixed array in an adhesive layer wherein the non-random particle locations corresponding to a plurality of predefined microcavity locations of arrays of microcavities for carrying and transferring the electrically conductive particles to the adhesive layer. The conductive particles are transferred sequentially in a first and then second array to an adhesive layer where they are embedded at different depths.

In addition to the above embodiment, this invention further discloses an electronic device with electronic components connected with an ACF of this invention. In a particular embodiment, the electronic device comprises a display device. In another embodiment, the electronic device comprises a semiconductor chip. In another embodiment, the electronic device comprises a printed circuit board with printed wire. In another preferred embodiment, the electronic device comprises a flexible printed circuit board with printed wire.

Having described the invention in detail and by reference to specific embodiments thereof, it will be apparent that numerous variations and modifications are possible without departing from the scope of the invention as defined by the following claims.

What is claimed is:

1. An anisotropic conductive film (ACF) comprising: (a) an adhesive layer having a substantially uniform thickness; and (b) a plurality of conductive particles individually adhered to the adhesive layer, wherein the conductive particles include a first non-random fixed array of particles partially embedded at a first depth within the adhesive layer, and a second fixed non-random array of conductive particles partially embedded at a second depth, or a dispersion of conductive particles fully embedded within the adhesive layer, wherein the first depth and the second depth are distinctly different.

2. The ACF of claim 1 wherein the ACF includes a first non-random array of particles partially embedded at a first depth within the adhesive layer and a second non-random array of conductive particles partially embedded at a second depth, and about 0 to 80% of the diameter of the particles in the first array and the second array is above the surface of the adhesive layer provided that the depths of the first and second arrays are distinctly different.

3. The ACF of claim 1 wherein at least about 10% of the partially embedded conductive particles, based on the diameter of the particles, in the first or the second array is exposed above the surface of the adhesive layer.

4. The ACF of claim 3 wherein at least about 30% of the partially embedded particles is exposed above the surface of the adhesive layer.

5. The ACF of claim 2 wherein the first array of conductive particles is embedded about 40 to 90% and the second array of conductive particles is embedded about 10 to 60% provided that the depths of the first and second arrays are distinctly different.

6. The ACF of claim 1 wherein the ACF includes a first non-random array of conductive particles partially embedded in the adhesive layer, and a dispersion of conductive particles that are fully embedded as a dispersion in the adhesive layer, and about 0 to 80% of the diameter of the conductive particles in the first array is above the surface of the adhesive layer.

7. The ACF of claim 6 wherein the ACF is obtained by transferring the first fixed array of particles onto the surface of the adhesive layer in an ACF in which conductive particles are randomly dispersed and fully embedded within the conductive adhesive layer.

8. The ACF of claim 6 wherein the ACF further comprises a separate non-conductive adhesive layer underlying the adhesive layer containing the dispersion of conductive particles.

9. The ACF of claim 1 wherein adhesive layer has orthogonal X and Y directions and the particles in a fixed non-random array have a pitch of about 3 to 30 μm in the X and/or Y direction.

10. The ACF of claim 9 wherein the particle sites are arranged in an array having a pitch of about 4 to 12 μm in the X and/or Y direction.

11. The ACF of claim 1 wherein the adhesive layer is about 5 to 35 μm thick.

12. The ACF of claim 11 wherein the adhesive layer is about 10 to 20 μm thick.

13. An anisotropic conductive film (ACF) comprising: (a) an adhesive layer having a substantially uniform thickness; and (b) a plurality of conductive particles individually adhered to the adhesive layer, wherein the conductive particles include a first non-random array of particles partially embedded at a first depth within the adhesive layer and a second non-random array of conductive particles partially embedded at a second depth within the adhesive layer the first depth and the second depths being distinctly different.

14. The ACF of claim 13 wherein the difference in the depths of the first array and the second array is at least about 20% of the particles diameter.

15. The ACF of claim 14 wherein the difference in the depths of the first array and the second array is at least about 30% of the particles diameter.

16. The ACF of claim 14 wherein at least about 10% of the partially embedded conductive particle based on the diameter of the particles in the first and second arrays is exposed above the surface of the adhesive layer.

17. The ACF of claim 16 wherein at least about 30% of the partially embedded particles forming the first array is exposed above the surface of the adhesive layer.

18. An electronic or display device or component comprising a cured or uncured ACF of claim 1.

19. The ACF of claim 18 wherein the electronic device is an integrated circuit or a printed circuit.

20. A method of making a multi-tiered ACF comprising the steps of:
(a) transferring a first fixed array of particles to an adhesive layer;
(b) processing the first array to the desirable degree of partial embedding;
(c) transferring a second fixed array of particles to the adhesive; and
(d) optionally pressing both arrays of particles to the desired degree of partial embedding such that the first array is embedded in the adhesive to a greater extent than the second array.

21. A method of making a multi-tiered ACF comprising the steps of:
(a) transferring a first fixed non-random array of particles to an adhesive layer of an ACF containing conductive particles; and
(b) processing the first array to the desirable degree of partial embedding.

22. The ACF of claim 1 in the form of a continuous film or roll

23. The ACF of claim 22 wherein the first array and the second array are located in limited areas of the continuous film or roll.
